(19) United States
(12) Patent Application Publication
(10) Pub. No.: US 2025/0035501 A1
(43) Pub. Date: Jan. 30, 2025

(54) PRESSURE TRANSDUCER

(71) Applicant: Endress+Hauser SE+Co. KG, Maulburg (DE)

(72) Inventors: Dietmar Leuthner, Weil am Rhein (DE); Sergey Lopatin, Lörrach (DE)

(21) Appl. No.: 18/706,963

(22) PCT Filed: Sep. 27, 2022
(86) PCT No.: PCT/EP2022/076766

§ 371 Date: May 2, 2024

(30) Foreign Application Priority Data
Nov. 4, 2021 (DE) 10 2021 128 733.2

(51) Int. Cl. G01L 19/00; G01L 19/04

(52) U.S. Cl. CPC G01L 19/0046; G01L 19/0023; G01L 19/0038; G01L 19/04

(57) ABSTRACT

A pressure transducer having a sensor module comprises a sensor body including a measuring cell chamber, in which a pressure measuring cell is contactable with a pressure via a first hydraulic path filled with a second pressure transfer liquid, and a transfer module for transferring a pressure to the first hydraulic path. The transfer module has, filled with a first pressure transfer liquid, a second hydraulic path, which extends from a process diaphragm through a transfer body to a transfer diaphragm. The transfer diaphragm is secured pressure-tightly on the transfer body. The sensor body is connected pressure-tightly with the transfer body in such a manner that the first hydraulic path is in communication with the transfer diaphragm such that the pressure of the second hydraulic path is transferable through the transfer diaphragm to the first hydraulic path.

The invention relates to a pressure transducer, to a method for operating such a pressure transducer, as well as to a use of such a pressure transducer in a measuring point of an automated plant.

Pressure transfer means in the form of diaphragm seals with hydraulic pressure transfer have, usually, a hydraulic path, which extends between a process diaphragm and a pressure measuring cell, wherein the process diaphragm is exposed to a process medium, whose pressure is to be ascertained. Currently, such pressure transfer means essentially use an oil, especially a silicone oil, as pressure transfer liquid.

The use of such pressure transfer means is problematic in the case of applications, in which the process medium has a high temperature and a low process pressure. An example is so-called vacuum applications, where the process medium has a temperature up to 400° C. and a process pressure less than 1 bar absolute pressure, since under these conditions the pressure transfer liquid can outgas, or evaporate, or decompose chemically to volatile materials. Such can in the most advantageous case occur reversibly according to the vapor pressure curve for the particular pressure transfer liquid, wherein, however, also in this case a plastic deformation of the process diaphragm is threatened, which leads to a measurement error. Frequently, the pressure transfer liquid behaves, however, not according to the vapor pressure curve for the pure and native state, for, because of reactions with impurities or with the surfaces bounding the hydraulic path, the pressure transfer liquid can contain volatile decomposition products, which after the outgassing no longer return into solution. In such cases, the decomposition products can develop such high pressures that the metal diaphragm bursts and hydraulic liquid from the pressure sensor contaminates the process medium.

It is, consequently, an object of the invention to overcome the disadvantages of the state of the art.

The object is achieved according to the invention by the pressure transducer as defined in claim 1.

The pressure transducer of the invention comprises a sensor module having
a sensor body, which includes a measuring cell chamber, in which a pressure measuring cell is arranged, wherein the pressure measuring cell is contactable with a pressure via a first hydraulic path filled with a second pressure transfer liquid, and
an, especially metal, transfer module for transferring a pressure to the first hydraulic path, wherein the transfer module has, filled with a first pressure transfer liquid different from the second pressure transfer liquid, a second hydraulic path, which extends from a process diaphragm through a transfer body to a transfer diaphragm,
the transfer diaphragm is secured pressure-tightly on the transfer body,
the sensor body is connected pressure-tightly with the transfer body in such a manner that the first hydraulic path is in communication with the transfer diaphragm, such that the pressure of the second hydraulic path is transferable through the transfer diaphragm to the first hydraulic path, and
the first pressure transfer liquid has a higher density than the second pressure transfer liquid.

According to the invention, a pressure transducer, particularly one equipped with a pressure transfer means, is provided; in the case of which two hydraulic paths are filled with two pressure transfer liquids having different densities, wherein the first pressure transfer liquid with the higher density is located in the second hydraulic path, which serves as isolation between the process medium and the sensor module, and the second pressure transfer liquid with the lower density is located in the first hydraulic path, which transfers the pressure transferred through the second pressure transfer liquid via the first hydraulic path to the pressure measuring cell.

An advantageous embodiment of the pressure transducer of the invention provides that the first pressure transfer liquid is an, especially eutectic, gallium based alloy, which, besides gallium, contains, furthermore, at least one other component, and the mixing ratio between gallium and the at least one additional component is selected in such a manner that the alloy has a melting temperature less than 20° C., especially less than 15° C. Especially, the embodiment can provide that the alloy can have a plurality of other components and the mixing ratios between gallium and the plurality of additional components is selected in such a manner that the alloy has a melting temperature less than 20° C., especially less than 15° C.

Another advantageous embodiment of the pressure transducer of the invention provides that the one or more other components are selected from metals having a melting point less than 450° C., preferably less than 350° C.

Another advantageous embodiment of the pressure transducer of the invention provides that the one or more other components are selected from indium, tin, zinc, lead, bismuth, and/or mercury.

Another advantageous embodiment of the pressure transducer of the invention provides that the alloy contains at least 50 mass percent, preferably at least 60 mass percent, gallium.

Another advantageous embodiment of the pressure transducer of the invention provides that the second pressure transfer liquid is a silicone oil.

The invention relates further to a method for operating a pressure transducer according to one of the above described embodiments in a measuring point of an automated plant for determining a pressure of a process medium contacting the process diaphragm, wherein the pressure transducer is introduced into the measuring point in such a manner that a hydrostatic pressure of the first pressure transfer liquid located in the second hydraulic path acts on the transfer diaphragm and, thus, also on the second pressure transfer liquid located in the first hydraulic path, so that the hydrostatic pressure of the first pressure transfer liquid acts counter to a process pressure of a medium contacting the process diaphragm.

An advantageous form of embodiment of the method of the invention provides that the pressure transducer is applied for determining the pressure of the process medium contacting the process diaphragm and having a process pressure <1 bar absolute at a process temperature ≤400° C.

The invention relates further to a use of a pressure transducer as defined in one of the above described embodiments in a measuring point of an automated plant for determining a pressure of a process medium contacting the process diaphragm and having a process pressure <1 bar absolute and a process temperature ≤400° C.

An advantageous variant of the use provides that the pressure transducer is introduced into the measuring point in such a manner that a hydrostatic pressure of the first pressure transfer liquid located in the second hydraulic path acts on the transfer diaphragm and, thus, also on the second pressure transfer liquid located in the first hydraulic path, so that the hydrostatic pressure of the first pressure transfer liquid acts counter to a process pressure of a medium contacting the process diaphragm.

The invention will now be explained in greater detail based on the appended drawing, the sole figure of which show as follows:

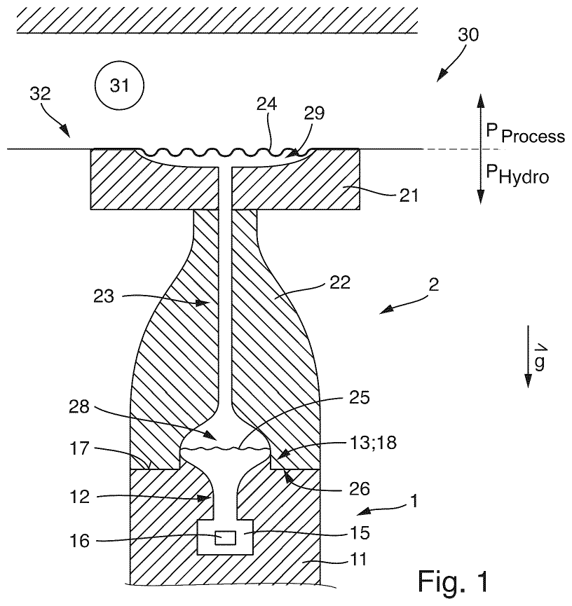

FIG. 1 a longitudinal section through a pressure transfer means formed according to the invention.

FIG. 1 shows a longitudinal section through a pressure transfer means formed according to the invention. Shown are a sensor module 1 and a transfer module 2 made of metal. Sensor module 1 includes a sensor body 11, which can have an at least sectionally cylindrical symmetry or other axial symmetry. Arranged in the interior of the sensor body 11 is a measuring cell chamber 15 having, located therein, a pressure measuring cell 16 and being connected via a measuring cell duct 12 with an end face 13 of the sensor body 11. End face 13 faces toward the transfer module 2. End face 13 can, additionally, be bounded by a circularly shaped assembly wall 17, which extends in the axial direction from the end face 13. Assembly wall 17 includes a first assembly end face 18, which according to a currently preferred embodiment is planar. First assembly end face 18 is connected pressure-tightly with a matching, second assembly face. Details for this are explained below following a description of the structure of the transfer module.

The transfer module 2 of metal includes, in a currently preferred embodiment, a process body 21 and a transfer body 22, which, in each case, can have, at least sectionally, cylindrical symmetry or rotational symmetry. These symmetries are not essential for the invention. They result, however, when the components of the pressure transducer are manufactured as turned parts.

Each of process body 21 and transfer body 22 has a traversing, axial bore between its end faces. The two bodies are pressure-tightly connected together, such that a capillary duct 23 extends between the far end faces of the process body and the transfer body.

A flexible process diaphragm 24 is secured pressure-tightly along its periphery on the sensor end face of the process body 21 facing away from the capillary duct 23. This forms between the process diaphragm 24 and the process body 21 a process pressure chamber 29, which is in communication with the capillary duct 23.

A flexible transfer diaphragm 25 is secured pressure-tightly along its periphery to the end face of the transfer body 22 facing away from the capillary duct 23. This forms between the transfer diaphragm 25 and the transfer body 22 a transfer pressure chamber 28, which is in communication with the capillary duct 23 and, as a result, with the process pressure chamber 29.

Process pressure chamber 29, capillary 23 and transfer pressure chamber 28 are filled with a first pressure transfer liquid and form a second hydraulic path.

In operation of the pressure transducer and pressure transfer means of the invention, thus, the process diaphragm 24 can be exposed to a process medium, and the pressure of the medium is transferred by means of the first pressure transfer liquid to the transfer diaphragm 25.

The sensor-side end face of the transfer body has the above mentioned second assembly face 26, with which the first assembly face of the sensor module is welded pressure-tightly.

The measuring cell chamber 15 as well as the volume between this and the transfer diaphragm 25, thus, the first hydraulic path, are filled with a second pressure transfer liquid. In this way, a pressure on the transfer diaphragm is transferred to the pressure measuring cell 16, so that such is supplied with a corresponding pressure for determining the pressure value. Usually, the filling occurs after the sensor body is connected with the transfer body along the first and second assembly faces. For this, there can be provided in the sensor module and in the transfer module filling ducts for filling the first and second hydraulic paths with pressure transfer liquids. Details for embodiment of the fill ducts and their closure are known to those skilled in the art and require no additional presentation.

According to the invention, used as first pressure transfer liquid is a liquid having a higher density than the density of a second pressure transfer liquid. For example, used as first pressure transfer liquid can be an alloy based on gallium, with at least 50 mass percent, preferably at least 60 mass percent gallium, and containing, besides gallium, furthermore, at least one other component, with the mixing ratio between gallium and the at least one additional component being selected in such a manner that the alloy has a melting temperature less than 20° C., especially less than 15° C. Preferably, the alloy is a eutectic alloy. The one or more other components can be especially metals having a melting point of less than 350° C., such as, for example, indium (157° C.), tin (232° C.), zinc (420° C.), lead (327° C.), bismuth (271° C.) and/or mercury (−38.8° C.), wherein it is to be noted that, while mercury is possible, it would not be used due to its toxicity.

Used as second pressure transfer liquid can be a liquid with lesser density than the density of the first pressure transfer liquid. In such case, especially standard transfer liquids can be applied, such as, for example, the above mentioned silicone oils usual in diaphragm seals of the state of the art.

By applying two pressure transfer liquids with different densities, the hydrostatic pressure p_{Hydro} of the fluid column of the hydraulic path filled with the pressure transfer liquid with the higher density can be increased.

For this, the pressure transfer means of the invention is mounted in such a manner in a measuring point 32 of an automated plant 30 that the hydrostatic pressure p_{Hydro} resulting from the fluid column of the second hydraulic path acts on the transfer diaphragm 25 and, thus, on the first hydraulic path located in the sensor module 1. In FIG. 1, this is effected, by way of example, in such a manner that the pressure transfer means is installed, mounted, on top in the measuring point, for example, a measuring tube. Fundamentally, the pressure transfer means does not need to be installed, in such case, exactly perpendicularly, such as shown in FIG. 1, but, rather, it is sufficient that the diaphragm seal is inclined relative to a “normal” installed position rotated virtually 180° to that shown in FIG. 1. As a result of this installed position as well as the use of pressure transfer liquids with different density, then, compared with a pressure transfer means in the form of a diaphragm seal filled with a single pressure transfer liquid, a higher pressure can be imposed on the first hydraulic path 12. This leads to the fact that the hydrostatic pressure p_{Hydro} acts counter to the process pressure p_{process} and, thus, durably prevents that a limit pressure in the first pressure transfer liquid in the sensor module 1 is subceeded. This leads, in turn, to the fact that an outgassing of the second pressure transfer liquid can be prevented.

Application of two pressure transfer liquids with different densities leads to yet another advantage, this being that the diaphragm seal has a lower temperature error. This results from the fact that the temperature dependent volume expansion, compared with a known diaphragm seal, in the case of which only a (single) pressure transfer liquid is used, behaves as follows: ΔV (standard transfer liquid)>>ΔV (gallium based alloy as pressure transfer liquid)>ΔV (metal, of which the pressure transfer means, especially the transfer module, is formed).

### LIST OF REFERENCE CHARACTERS

1 sensor module
2 transfer module
11 sensor body
12 measuring cell duct/first hydraulic path
13 first end face
15 measuring cell chamber
16 pressure measuring cell
17 assembly wall
18 first assembly end face
21 process body
22 transfer body
23 traversing capillary duct/second hydraulic path
24 process diaphragm
25 transfer diaphragm
26 second assembly end face
28 transfer pressure chamber
29 process pressure chamber
30 automated plant
31 process medium
32 measuring point
g force of gravity
P_{Process} process pressure
P_{Hydro} hydrostatic pressure

1-11. (canceled)

12. A pressure transducer having a sensor module, comprising:
a sensor body, which includes a measuring cell chamber, in which a pressure measuring cell is arranged, wherein the pressure measuring cell is contactable with a pressure via a first hydraulic path filled with a second pressure transfer liquid, and
an, especially metal, transfer module for transferring a pressure to the first hydraulic path, wherein the transfer module has, filled with a first pressure transfer liquid different from the second pressure transfer liquid, a second hydraulic path, which extends from a process diaphragm through a transfer body to a transfer diaphragm,
the transfer diaphragm is secured pressure-tightly on the transfer body,
the sensor body is connected pressure-tightly with the transfer body in such a manner that the first hydraulic path is in communication with the transfer diaphragm, such that the pressure of the second hydraulic path is transferable through the transfer diaphragm to the first hydraulic path, and
the first pressure transfer liquid has a higher density than the second pressure transfer liquid.

13. The pressure transducer as claimed in claim 12, wherein the first pressure transfer liquid is a gallium based alloy including at least one other component, wherein the mixing ratio between gallium and the at least one additional component is selected in such a manner that the alloy has a melting temperature less than 20° C.

14. The pressure transducer as claimed in claim 13, wherein the alloy can have a plurality of other components and the mixing ratios between gallium and the plurality of additional components is selected in such a manner that the alloy has a melting temperature less than 20° C.

15. The pressure transducer as claimed in claim 12, wherein the one or more other components are selected from metals having a melting point less than 450° C.

16. The pressure transducer as claimed in claim 12, wherein the one or more other components are selected from indium, tin, zinc, lead, bismuth, and/or mercury.

17. The pressure transducer as claimed in claim 12, wherein the alloy contains at least 50 mass percent gallium.

18. The pressure transducer as claimed in claim 12, wherein the second pressure transfer liquid is a silicone oil.

19. A method for operating a pressure transducer in a measuring point of an automated plant for determining a pressure of a process medium contacting the process diaphragm,
wherein the pressure transducer includes:
a sensor body, which includes a measuring cell chamber, in which a pressure measuring cell is arranged, wherein the pressure measuring cell is contactable with a pressure via a first hydraulic path filled with a second pressure transfer liquid, and
a transfer module for transferring a pressure to the first hydraulic path, wherein the transfer module has, filled with a first pressure transfer liquid different from the second pressure transfer liquid, a second hydraulic path, which extends from a process diaphragm through a transfer body to a transfer diaphragm,
the transfer diaphragm is secured pressure-tightly on the transfer body,
the sensor body is connected pressure-tightly with the transfer body in such a manner that the first hydraulic path is in communication with the transfer diaphragm, such that the pressure of the second hydraulic path is transferable through the transfer diaphragm to the first hydraulic path, and
the first pressure transfer liquid has a higher density than the second pressure transfer liquid
wherein the method includes:
introducing the pressure transducer into the measuring point in such a manner that a hydrostatic pressure (p_{Hydro}) of the first pressure transfer liquid located in the second hydraulic path acts on the transfer diaphragm and, thus, also on the second pressure transfer liquid located in the first hydraulic path, so that the hydrostatic pressure (p_{Hydro}) of the first pressure transfer liquid acts counter to a process pressure (p_{process}) of a medium contacting the process diaphragm.

20. The method of claim 19, wherein the pressure transducer is applied for determining the pressure of the process medium contacting the process diaphragm and having a process pressure <1 bar absolute at a process temperature ≤400° C.

21. A method for using a pressure transducer in a measuring point of an automated plant, wherein the pressure transducer includes:
a sensor body, which includes a measuring cell chamber, in which a pressure measuring cell is arranged, wherein the pressure measuring cell is contactable with a pressure via a first hydraulic path filled with a second pressure transfer liquid, and
a transfer module for transferring a pressure to the first hydraulic path, wherein the transfer module has, filled with a first pressure transfer liquid different from the second pressure transfer liquid, a second hydraulic path, which extends from a process diaphragm through a transfer body to a transfer diaphragm,
the transfer diaphragm is secured pressure-tightly on the transfer body,
the sensor body is connected pressure-tightly with the transfer body in such a manner that the first hydraulic path is in communication with the transfer diaphragm, such that the pressure of the second hydraulic path is transferable through the transfer diaphragm to the first hydraulic path, and
the first pressure transfer liquid has a higher density than the second pressure transfer liquid,
wherein the method includes:
determining a pressure of a process medium contacting the process diaphragm and having a process pressure <1 bar absolute and a process temperature ≤400° C.

22. The method of claim 21, wherein the pressure transducer is introduced into the measuring point in such a manner that a hydrostatic pressure of the first pressure transfer liquid located in the second hydraulic path acts on the transfer diaphragm and, thus, also on the second pressure transfer liquid located in the first hydraulic path, so that the hydrostatic pressure (p_{Hydro}) of the first pressure transfer liquid acts counter to a process pressure (p_{process}) of a medium contacting the process diaphragm.
